(19) United States
(12) Patent Application Publication
(10) Pub. No.: US 2013/0027640 A1
(43) Pub. Date: Jan. 31, 2013

(54) LIQUID CRYSTAL DISPLAY DEVICE, METHOD FOR MANUFACTURING THE SAME AND METHOD FOR MANUFACTURING SUBSTRATE FOR ALIGNMENT OF LIQUID CRYSTAL

(71) Applicants: Sin-Doo Lee, Seoul (KR); Deog-Kyoon Jeong, Seoul (KR); Jun-Hee Na, Seoul (KR)

(72) Inventors: Sin-Doo Lee, Seoul (KR); Deog-Kyoon Jeong, Seoul (KR); Jun-Hee Na, Seoul (KR)

(73) Assignee: SNU R&DB FOUNDATION, Seoul (KR)

(21) Appl. No.: 13/640,108

(22) PCT Filed: Aug. 4, 2010
(86) PCT No.: PCT/KR2010/005116

§ 371 Date: Oct. 9, 2012

(30) Foreign Application Priority Data
Jun. 1, 2010 (KR) 10-2010-0051836

(51) Int. Cl. G02F 1/1335; B05D 3/06; B05D 3/00; G02F 1/1337

(52) U.S. Cl. 349/96; 349/123; 349/189; 427/259; 427/555; 427/553

(57) ABSTRACT

A method for manufacturing a substrate for alignment of a liquid crystal may include: forming a vertical alignment layer on a substrate; performing an alignment process on the vertical alignment layer in a first direction; forming a protective layer at a partial region of the vertical alignment layer; performing an alignment process on other regions of the vertical alignment layer in a second direction; and removing the protective layer. A liquid crystal display device manufactured using the substrate for alignment of a liquid crystal ensures wide viewing angle and alignment stability with relatively simple processes as compared with the conventional vertically aligned (VA) mode liquid crystal display device.

### TECHNICAL FIELD

This disclosure relates to a liquid crystal display device, a method for manufacturing the same, and a method for manufacturing a substrate for alignment of liquid crystal.

### BACKGROUND ART

A vertically aligned (VA) mode liquid crystal display device has high contrast ratio and excellent light transmittance as compared with a twisted nematic (TN) mode liquid crystal display device, and has advantages of quick response time and simple manufacturing processes. Further, the VA mode liquid crystal display device has an advantage of low dependence on the wavelength of incident light as compared with the TN mode liquid crystal display device.

However, a large-size VA mode liquid crystal display device requires a relatively wide viewing angle. In order to obtain the wide viewing angle, methods of forming protrusions on a substrate or generating a slant electric field by a patterned electrode and the like have been used to obtain multi-domain effect. However, these methods require complex processes such as application of a photoresist, development, lithography, and etching and have problems in that an alignment layer may be physically and chemically damaged by a solvent used for those processes and thus characteristics are degraded. As another method, there is a multi-domain alignment technique using optical alignment. However, this method has a problem with low anchoring energy and a reliability problem caused as initial alignment characteristics are deteriorated with time.

### DISCLOSURE

### Technical Problem

Embodiments provide a new liquid crystal display device which has a relatively simple manufacturing process, can assure a wide viewing angle and alignment stability, and can achieves a high-performance liquid crystal display device at low cost as compared with the conventional vertically aligned (VA) mode liquid crystal display. Embodiments also provide a method for manufacturing the liquid crystal display device and a method for manufacturing a substrate for alignment of liquid crystal.

### Technical Solution

In one embodiment, a liquid crystal display device includes: a first substrate; a second substrate opposed to the first substrate; a first vertical alignment layer disposed on the first substrate and includes a first region having a first alignment direction and a second region having a second alignment direction; a second vertical alignment layer disposed on the second substrate to be opposed to the first vertical alignment layer and includes a third region having a third alignment direction and a fourth region having a fourth alignment direction; and a liquid crystal interposed between the first vertical alignment layer and the second vertical alignment layer. Here, the first to fourth alignment directions may be different from one another.

In one embodiment, a method for manufacturing a substrate for alignment of a liquid crystal includes: forming a vertical alignment layer on a substrate; performing an alignment process on the vertical alignment layer in a first direction; forming a protective layer at a partial region of the vertical alignment layer; performing an alignment process on other regions of the vertical alignment layer in a second direction; and removing the protective layer.

In one embodiment, a method for manufacturing a liquid crystal display device includes: forming on a first substrate a first vertical alignment layer including a first region and a second region having different alignment directions; forming on a second substrate a second vertical alignment layer including a third region and a fourth region having different alignment directions; disposing the first vertical alignment layer and the second vertical alignment layer to be opposed to each other so that alignment directions of the first alignment layer and the second vertical alignment layer are different from each other; and injecting a liquid crystal between the first vertical alignment layer and the second vertical alignment layer.

### Advantageous Effects

According to embodiments, multi-domain alignment is achieved using a protective layer including fluoropolymer, so that problems of low contrast ratio and narrow viewing angle in the conventional twisted nematic (TN) mode liquid crystal display device can be solved. Further, as compared with the conventional multi-domain vertically aligned (VA) mode liquid crystal display device using protrusions formed on the substrate or patterned electrodes, the manufacturing processes are much simpler. Furthermore, since a photolithography process is not used for forming and removing the protective layer, damage to the alignment layer or alignment instability which is caused by a solvent used for applying or developing a photoresist can be reduced or removed. Therefore, it is possible to manufacture a high-definition liquid crystal display device with excellent contrast ratio, viewing angle, and side visibility through simple processes.

### DESCRIPTION OF DRAWINGS

The above and other aspects, features and advantages of the disclosed example embodiments will be more apparent from the following detailed description taken in conjunction with the accompanying drawings in which:

FIG. 1 is a perspective view schematically illustrating a liquid crystal display device according to an example embodiment;

FIG. 2 is a view schematically illustrating alignment of liquid crystal in the liquid crystal display of FIG. 1;

FIG. 3 is a perspective view schematically illustrating the liquid crystal display according to an example embodiment, which is applied with a voltage;

FIG. 4 is a view schematically illustrating a twisted alignment direction of liquid crystal in the liquid crystal display device of FIG. 3;

FIG. 5 is a view schematically illustrating a pretilt angle of the liquid crystal depending on the alignment direction;

FIG. 6 is a cross-sectional view schematically illustrating vertical alignment of liquid crystal in a case where the liquid crystal display device according to an example embodiment is not applied with a voltage;

FIG. 7 is a cross-sectional view schematically illustrating twisted alignment of liquid crystal in a case where the liquid crystal display device of FIG. 6 is applied with a voltage;

FIG. 8 is a perspective view schematically illustrating a liquid crystal display device according to an example embodiment;

FIGS. 9 to 14 are perspective views schematically illustrating a method for manufacturing the liquid crystal display device according to an example embodiment;

FIGS. 15 to 18 are optical micrographs taken by changing a voltage applied to the liquid crystal display device according to an example embodiment;

FIG. 19 is a graph showing light transmittance with respect to a voltage applied to the liquid crystal display device according to an example embodiment;

FIG. 20 is a graph showing response time and light transmittance depending on an AC voltage applied to the liquid crystal display device according to an example embodiment;

FIG. 21 is a graph showing a luminance distribution in a case where the liquid crystal display device according to an example embodiment is not applied with a voltage;

FIG. 22 is a graph showing a luminance distribution in a case where the liquid crystal display device according to an example embodiment is applied with a voltage;

FIG. 23 is a graph showing viewing angle of a conventional liquid crystal display device; and

FIG. 24 is a graph showing viewing angle of the liquid crystal display device according to an example embodiment.

### MODE FOR INVENTION

Embodiments now will be described more fully hereinafter with reference to the accompanying drawings, in which example embodiments are shown. This disclosure may, however, be embodied in many different forms and should not be construed as limited to the example embodiments set forth therein. Rather, these example embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the”are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

In the description of the embodiments in this disclosure, in order to clarify the essential of the invention, description of factors that can be easily understood by those skilled in the art from conventional liquid crystal display devices will be omitted.

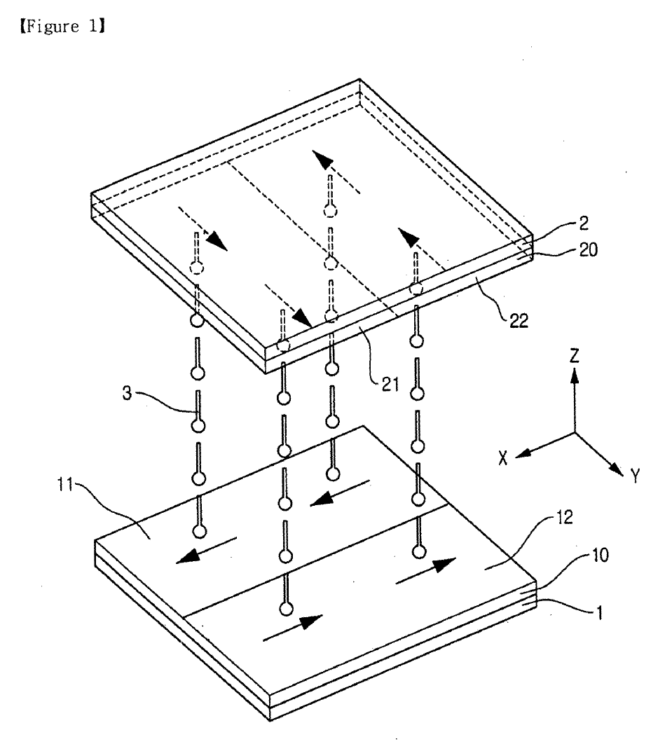

FIG. 1 is a perspective view schematically illustrating a liquid crystal display device according to an example embodiment.

Referring to FIG. 1, the liquid crystal display device according to the example embodiment may include a first substrate 1, a second substrate 2, a first vertical alignment layer 10, a second vertical alignment layer 20, and liquid crystal 3. The first and second substrates 1 and 2 may be spaced from each other. Further, the first and second substrates 1 and 2 may be opposed to each other. For example, the first and second substrates 1 and 2 may be arranged at least partially in parallel with each other. The first and second substrates 1 and 2 may be made of glass, plastic, or other suitable materials. A gate bus line, a data bus line, a thin-film transistor, and the like may be formed on the first substrate 1. A color filter and the like may be formed on the second substrate 2.

The liquid crystal 3 may be arranged by an electric field applied between the first and second substrates 1 and 2. For alignment of the liquid crystal 3, the first vertical alignment layer 10 may be formed on the first substrate 1, and the second vertical alignment layer 20 may be formed on the second substrate 2. The liquid crystal 3 may be injected between the first and second vertical alignment layers 10 and 20. Here, the liquid crystal 3 may be in a fluid state. It is easily understood by those skilled in the art that, although the liquid crystal 3 is schematically illustrated as several liquid crystal molecules for explanation of the alignment in the attached drawings, the liquid crystal 3 illustrated in the drawings does not represent actual state, size, and/or the number of liquid crystal molecules.

The first and second vertical alignment layers 10 and 20 may be made of a material having vertical alignment characteristics so that the longitudinal axis of the liquid crystal 3 is arranged in a perpendicular direction to the surfaces of the first and second vertical alignment layers 10 and 20 when a voltage is not applied. For example, the first and second vertical alignment layers 10 and 20 may include material selected from the group consisting of a polyimide-based resin, a polyvinyl alcohol-based resin, a polyamic acid-based resin, and a combination thereof. The first and second vertical alignment layers 10 and 20 may include other suitable materials. Further, the first and second vertical alignment layers 10 and 20 may include a hydrophobic resin with a relatively low surface energy. For example, as the material of the first and second vertical alignment layers 10 and 20, a vertical alignment polyimide resin AL60702 manufactured by JSR Corporation may be used.

The first vertical alignment layer 10 may include first and second regions 11 and 12 having different alignment directions from each other. Since the first vertical alignment layer 10 has vertical alignment characteristics, the liquid crystal 3 is arranged in a direction perpendicular to the surface of the first vertical alignment layer 10 (i.e., a normal direction of the first vertical alignment layer 10) in a state where no voltage is applied. However, by performing an alignment process such as rubbing or light irradiation on the first alignment layer 10, the liquid crystal 3 may be inclined at a predetermined pretilt angle. As used herein, the alignment direction refers to a horizontal component of the inclination direction of the liquid crystal 3 from the normal line of the first vertical alignment layer 10.

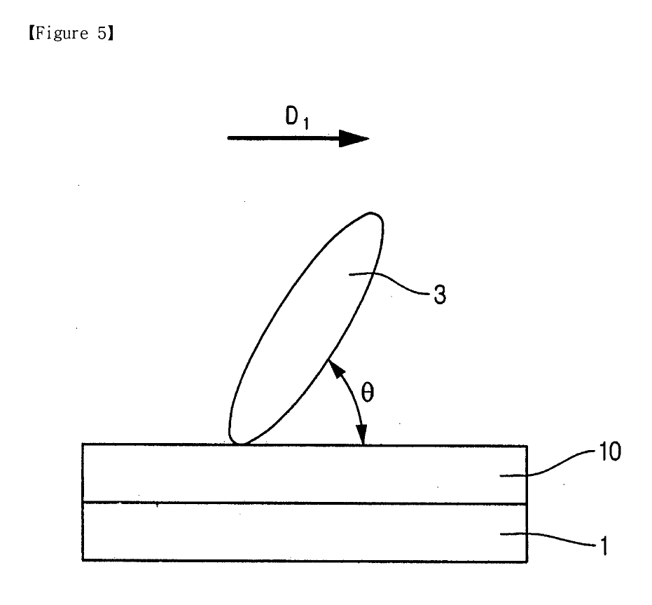

For example, FIG. 5 is a view schematically illustrating a liquid crystal positioned on the first vertical alignment layer subjected to the alignment process in one direction.

Referring to FIG. 5, the first vertical alignment layer 10 may be subjected to the alignment process in a predetermined alignment direction D1. As a result, the liquid crystal 3 positioned adjacent to the surface of the first vertical alignment layer 10 is arranged to be inclined along the alignment direction D1 from the normal line direction of the first vertical alignment layer 10. Herein, the liquid crystal 3 may have a predetermined angle e with respect to the surface of the first substrate 1, and as used herein, this angle is referred to as the pretilt angle. Therefore, the liquid crystal 3 may have a pretilt angle of 90° at the maximum, and an inclination direction of the liquid crystal 3 on the plane parallel to the surface of the first vertical alignment layer 10 is determined depending on an alignment direction of the first vertical alignment layer 10.

Referring back to FIG. 1, the first vertical alignment layer 10 may include a plurality of regions having different alignment directions from each other. For example, the first vertical alignment layer 10 may include a first region 11 subjected to the alignment process in one direction and a second region 12 subjected to the alignment process in a direction different from the one direction. In FIG. 1, arrows on the first and second regions 11 and 12 indicate the alignment directions of the corresponding regions. For example, the first and second regions 11 and 12 are subjected to the alignment process by rubbing, and in a case where the first vertical alignment layer 10 is made of a material aligned along the rubbing direction with a pretilt angle with respect to the surface, the arrows on the first and second regions 11 and 12 may be matched with the rubbing directions of the corresponding regions 11 and 12.

In an example embodiment, the first and second regions 11 and 12 may have opposite alignment directions from each other. For example, the first and second regions 11 and 12 may be rubbed in opposite directions from each other. That is, in a case where the first region 11 is subjected to the alignment process in +x direction, the second region 12 may be subjected to the alignment process in −x direction. Further, in an example embodiment, the area of the first region 11 may be the same as that of the second region 12. However, this disclosure is not limited thereto.

As a result of the alignment process of the first and second regions 11 and 12, the liquid crystal 3 adjacent to the first and second regions 11 and 12 may be arranged with a pretilt angle with respect to the surface of the first substrate 1. Herein, the pretilt angle of the liquid crystal 3 may be small so as not to change the overall vertical alignment characteristics of the liquid crystal 3. For example, the liquid crystal 3 adjacent to the first vertical alignment layer 10 may be arranged to have a pretilt angle of from about 45° to about 90° with respect to the surface of the first substrate 1. Herein, since the alignment directions of the first and second regions 11 and 12 are different from each other, the liquid crystal 3 adjacent to the first region 11 and the liquid crystal 3 adjacent to the second region 12 are arranged in different directions from each other on the x-y plane.

The second vertical alignment layer 20 may also have a plurality of regions having different alignment directions from each other. For example, the second vertical alignment layer 20 may include a third region 21 subjected to the alignment process in one direction and a fourth region 22 subjected to the alignment process in a direction different from the one direction. In FIG. 1, arrows on the third and fourth regions 21 and 22 represent alignment directions of the corresponding regions.

In an example embodiment, the third and fourth regions 21 and 22 may have opposite alignment directions from each other. For example, in a case where the third region 21 is subjected to the alignment process in +y direction, the fourth region 22 may be subjected to the alignment process in −y direction. Further, in an example embodiment, the area of the third region 21 may be the same as that of the fourth region 22. However, this disclosure is not limited thereto.

As a result of the alignment process of the third and fourth regions 21 and 22, the liquid crystal 3 adjacent to the third and fourth regions 21 and 22 may be arranged with a pretilt angle with respect to the surface of the second substrate 2. For example, the liquid crystal 3 adjacent to the second vertical alignment layer 20 may be arranged to have a pretilt angle of from about 45° to about 90° with respect to the surface of the second substrate 2. However, since the alignment directions of the third and fourth regions 21 and 22 are different from each other, the liquid crystal 3 adjacent to the third region 21 and the liquid crystal 3 adjacent to the fourth region 22 are arranged in different directions from each other on the x-y plane.

In FIG. 1, it is illustrated that the first vertical alignment layer 10 includes the single first region 11 and the single second region 12. However, this is only an example, and the first vertical alignment layer 10 may have a plurality of first regions 11 and a plurality of second regions 12. In this case, the first and second regions 11 and 12 may be alternately arranged. Similarly, the second vertical alignment layer 20 may also have a plurality of third regions 21 and a plurality of fourth regions 22, which are alternately arranged.

The liquid crystal display device may be manufactured by disposing the first and second vertical alignment layers 10 and 20 to be opposed in proximity to each other, and injecting the liquid crystal 3 therebetween. Herein, the first and second vertical alignment layers 10 and 20 may be disposed so that the alignment directions thereof are different from each other. In an example embodiment, the alignment direction of the first vertical alignment layer 10 and the alignment direction of the second vertical alignment layer 20 may be arranged to form an angle of from about 45° to about 135°. That is, the first and .second vertical alignment layers 10 and 20 may be disposed so that the alignment direction of the first region 11 and the alignment direction of the third region 13 form an angle of from about 45° to about 135°.

In an example embodiment, the first and second vertical alignment layers 10 and 20 may be arranged so that the alignment directions thereof are perpendicular to each other. For example, in a case where the alignment direction of the first region 11 is the +x direction and the alignment direction of the second region 12 is the −x direction, the alignment direction of the third region 21 may be the +y direction, and the alignment direction of the fourth region 22 may be the −y direction. In this case, the first and second regions 10 and 20 may cross the third and fourth regions 21 and 22 perpendicularly.

In the liquid crystal display device having the above-described configuration, the first and second vertical alignment layers 10 and 20 each have two regions having different alignment directions from, each other, and the first and second vertical alignment layers 10 and 20 may be disposed so that the alignment directions thereof are different from each other. As a result, a pixel region where the liquid crystal 3 is positioned between the first and second vertical alignment layers 10 and 20 may be divided into four portions where alignment characteristics are different from one another. As used herein, each of the portions where the alignment characteristics are different is referred to as a sub-pixel.

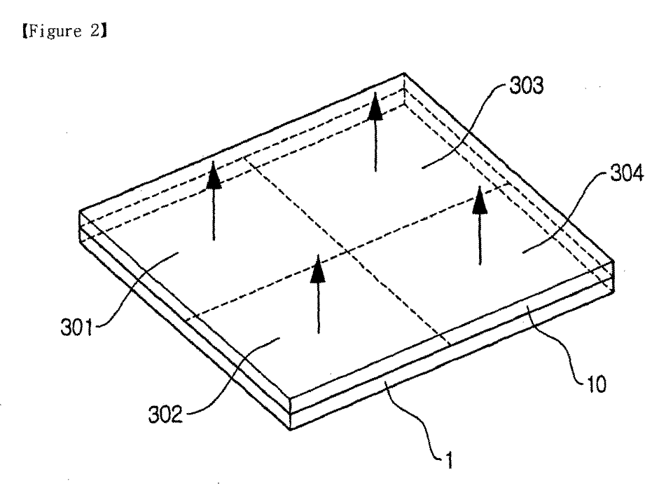

FIG. 2 is a view schematically illustrating sub-pixels divided from the region where the liquid crystal is positioned in the liquid crystal display device illustrated in FIG. 1. Arrows in FIG. 2 represent alignments of the liquid crystal in the corresponding sub-pixels.

Referring to FIGS. 1 and 2, the pixel region where the liquid crystal 3 is positioned may be divided into four sub-pixels 301, 302, 303, and 304 depending on the alignment directions of the first and second vertical alignments layers 10 and 20. The first sub-pixel 301 is positioned between the first and third regions 11 and 21, and the second sub-pixel 302 is positioned between the second and third regions 12 and 21. Further, the third sub-pixel 303 is positioned between the first and fourth regions 11 and 22, and the fourth sub-pixel 304 is positioned between the second and fourth regions 12 and 22.

In a state where no voltage is applied to the liquid crystal display device, the liquid crystal 3 may be arranged in a direction substantially perpendicular to the surface of the first and second substrates 1 and 2 on all the first to fourth sub-pixels 301, 302, 303, and 304 on average. The liquid crystal 3 in an area adjacent to the surfaces of the first and second vertical alignment layers 10 and 20 is arranged at a pretilt angle with respect to the first and second substrates 1 and 2 locally. However, since the pretilt angle in this case is relatively small, optical effects similar to those in the case of the vertical alignment can be exhibited. For example, the pretilt angle of the liquid crystal 3 with respect to the surfaces of the first and second substrates 1 and 2 may range from about 45° to about 90°.

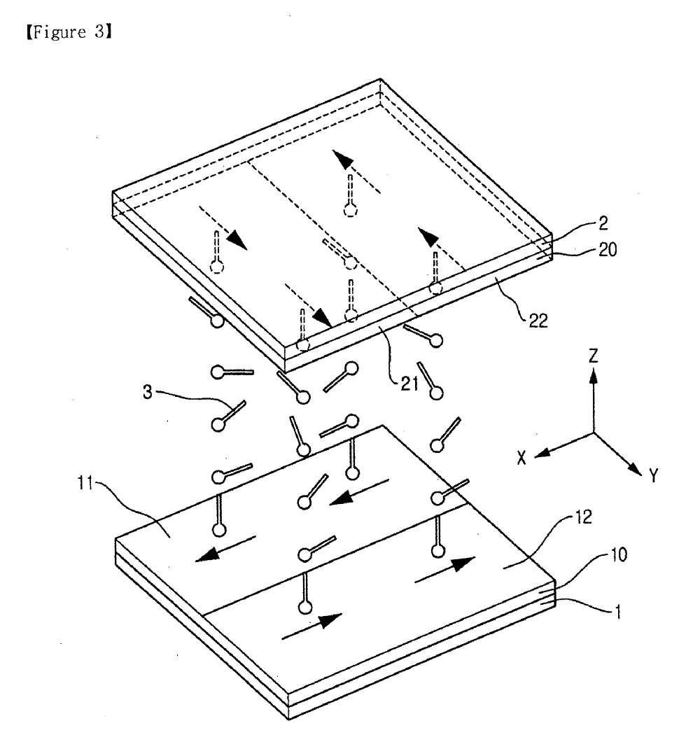

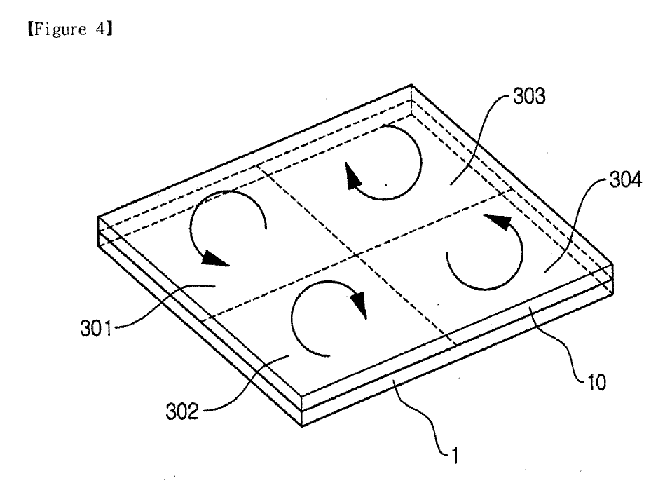

FIG. 3 is a perspective view schematically illustrating the liquid crystal display according to an example embodiment, which is applied with a voltage. FIG. 4 is a view schematically illustrating a twisted alignment direction of liquid crystal in the liquid crystal display device of FIG. 3.

Referring to FIGS. 3 and 4, when a voltage is applied to the liquid crystal display device, the liquid crystal 3 is rearranged into a twisted nematic (TN) form based on the alignment directions of the first and second vertical alignment layers 10 and 20. In an inverted twisted nematic (ITN) mode of a conventional mono-domain alignment liquid crystal display device, liquid crystal is simply rearranged in a TN form from an initial vertical alignment stage. However, in the liquid crystal display device according to the example embodiment illustrated in FIGS. 3 and 4, the liquid crystal 3 is twisted in different directions on the sub-pixels 301, 302, 303, and 304, thereby obtaining multi-domain alignment.

FIGS. 6 and 7 are perspective views for schematically explaining twist of the liquid crystal as a voltage is applied to the liquid crystal display device. FIG. 6 illustrates vertical alignment of the liquid crystal in the case where no voltage is applied to the liquid crystal display, and FIG. 7 illustrates twisted alignment of the liquid crystal in the case where a voltage is applied to the liquid crystal display device.

Referring to FIG. 6, in the state where no voltage is applied, the liquid crystal 3 may be arranged in a substantially vertical direction with respect to the surfaces of the first and second substrates 1 and 2 on average. Here, the liquid 3 is inclined along the alignment direction in the region adjacent to the first and second vertical alignment layers 10 and 20 and has a pretilt angle with respect to the surfaces of the first and second substrates 1 and 2. However, since the pretilt angle is relatively small, the liquid crystal 3 may represent optically similar to the case of the vertical alignment.

Referring to FIG. 7, when an electric field is applied between the first and second substrates 1 and 2 by an AC power source 4, the liquid crystal 3 arranged perpendicularly to the surfaces of the first and second substrates 1 and 2 may be twisted so as to be arranged in parallel with the surfaces of the first and second substrates 1 and 2. The twisting direction of the liquid crystal 3 is determined by the pretilt angle of the liquid crystal 3. Since the alignment directions of the first and second vertical alignment layers 10 and 20 are different, the twisting direction of the liquid crystal 3 at a part adjacent to the first vertical alignment layer 10 is different from that at a part adjacent to the second vertical alignment layer 20. For example, when the alignment directions of the first and second vertical alignment layers 10 and 20 are perpendicular to each other, the liquid crystal 3 adjacent to the first vertical alignment layer 10 and the liquid crystal 3 adjacent to the second vertical alignment layer 20 may be arranged to be perpendicular to each other.

Referring back to FIGS. 3 and 4, the region where the liquid crystal 3 is positioned in the liquid crystal display device according to the example embodiment is divided into the first to fourth sub-pixels 301, 302, 303, and 304 according to a combination of the alignment directions of the first and second vertical alignment layers 10 and 20. The liquid crystal 3 between the first and second vertical alignment layers 10 and 20 is twisted in different directions in the sub-pixels 301, 302, 303, and 304 from one another as the voltage is applied. The arrows on the sub-pixels 301, 302, 303, and 304 in FIG. 4 represent the twisting directions of the liquid crystal 3 in the corresponding sub-pixels. As illustrated, the twisting directions of the liquid crystal 3 in the sub-pixels 301, 302, 303, and 304 are different from one another, and this indicates that the liquid crystal display device has the multi-domain alignment.

In the example embodiments described above, the, first and second vertical alignment layers 10 and 20 each have two regions with different alignment directions, and as a result, the multi-domain alignment liquid crystal display device includes four sub-pixels 301, 302, 303, and 304. However, this is only an example, and the number of sub-pixels may be changed depending on the number of regions included in the first and second vertical alignment layers 10 and 20. For example, the number of the sub-pixels may be increased to 6, 8, or larger to configure a multi-domain alignment liquid crystal display device.

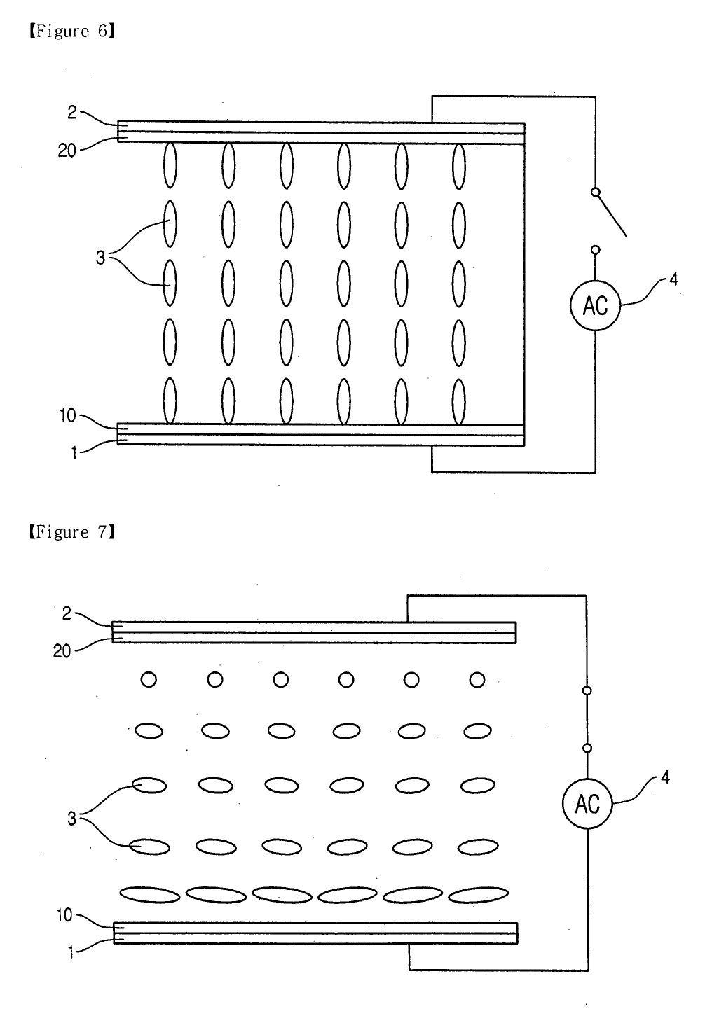

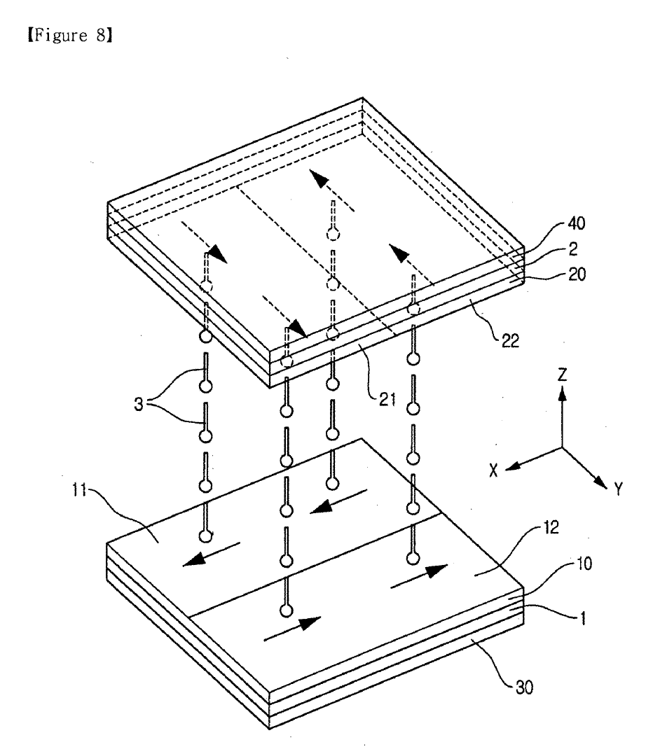

FIG. 8 is a perspective view schematically illustrating a liquid crystal display device according to an example embodiment. In the description of the example embodiment illustrated in FIG. 8, a detailed description that can be understood by those skilled in the art from the aforementioned example embodiments will be omitted.

Referring to FIG. 8, the liquid crystal display device according to the example embodiment may further include a first polarizing plate 30 and a second polarizing plate 40. The first and second polarizing plates 30 and 40 may be positioned on outer sides of the first and second substrates 1 and 2, respectively. That is, the first polarizing plate 30 maybe positioned on the surface of the first substrate 1 on the opposite side to the first vertical alignment layer 10, and the second polarizing plate 40 may be positioned on the surface of the second substrate 2 on the opposite side to the second polarizing plate 40.

Polarization directions of the first and second polarizing plates 30 and 40 may be suitably determined on the basis of the alignment directions of the first and second vertical alignment layers 10 and 20 and the pretilt angle depending on the alignment directions. The polarization directions of the first and second polarizing plates 30 and 40 may be different from each other, and may form an angle of from 0 to about 90° on the x-y plane. For example, the polarization directions of the first and second polarizing plates 30 and 40 may be perpendicular to each other. Further, the polarization direction of the first polarizing plate 30 may be a direction parallel to the alignment direction of the first vertical alignment layer 10 (for example, the x-axis direction). Furthermore, the polarization direction of the second polarizing plate 40 may be a direction parallel to the alignment direction of the second vertical alignment layer 20 (for example, the y-axis direction). As a result, light transmittance through the liquid crystal display device can be maximized.

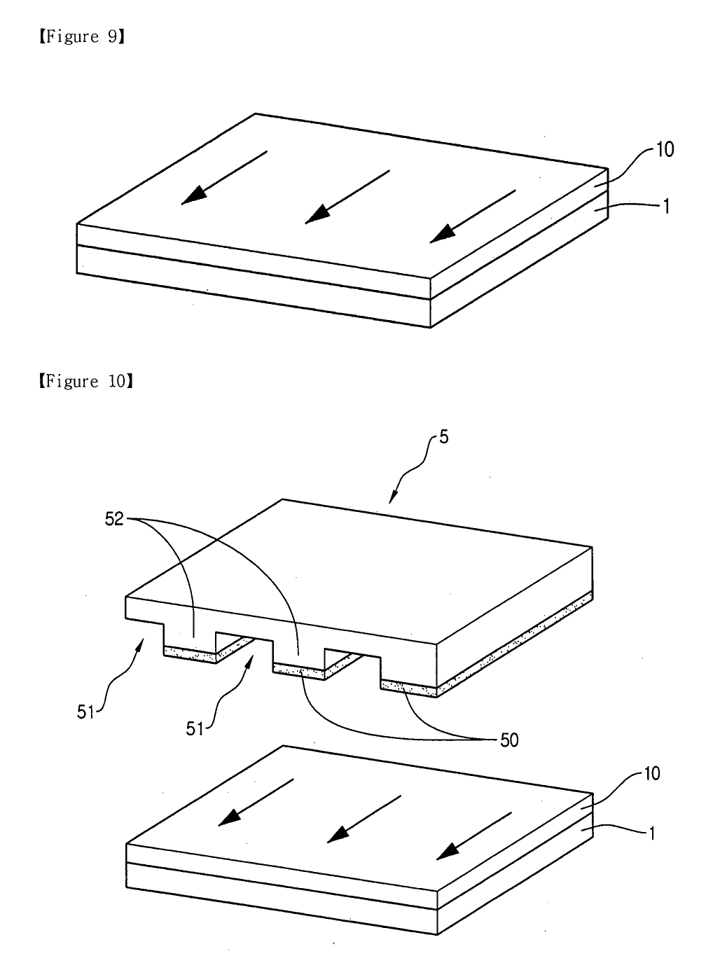

FIGS. 9 to 14 are perspective views schematically illustrating a method for manufacturing the liquid crystal display device according to an example embodiment.

Referring to FIG. 9, the first vertical alignment layer 10 may be formed on the first substrate 1. The first substrate 1 may be made of glass, plastic, or other suitable materials. Further, the first vertical alignment layer 10 may include a polyimide-based resin, a polyvinyl alcohol-based resin, a polyamic acid-based resin, or other suitable materials. Then, the first vertical alignment layer 10 may be subjected to the alignment process in one direction. For example, the first vertical alignment layer 10 may be subjected to the alignment process by performing rubbing or light irradiation on the first vertical alignment layer 10. As a result, the first vertical alignment layer 10 may have a pretilt angle formed thereon in the one direction.

Referring to FIG. 10, a stamping mold 5 may be prepared, and a protective layer 50 may be formed on the stamping mold 5. The stamping mold 5 may be made of an elastomer such as polydimethylsiloxane (PDMS) or other suitable materials. The stamping mold 5 may have an uneven structure including one or more recessed portions 51 and one or more protruding portions 52. The size of the uneven structure may be suitably determined depending on the size of the sub-pixel to be formed. In the uneven structure, the recessed portion 51 and the protruding portion 52 may be formed at a regular interval. Further, the widths of the recessed portion 51 and the protruding portion 52 may be the same. The protective layer 50 may be formed on each of the protruding portions 52.

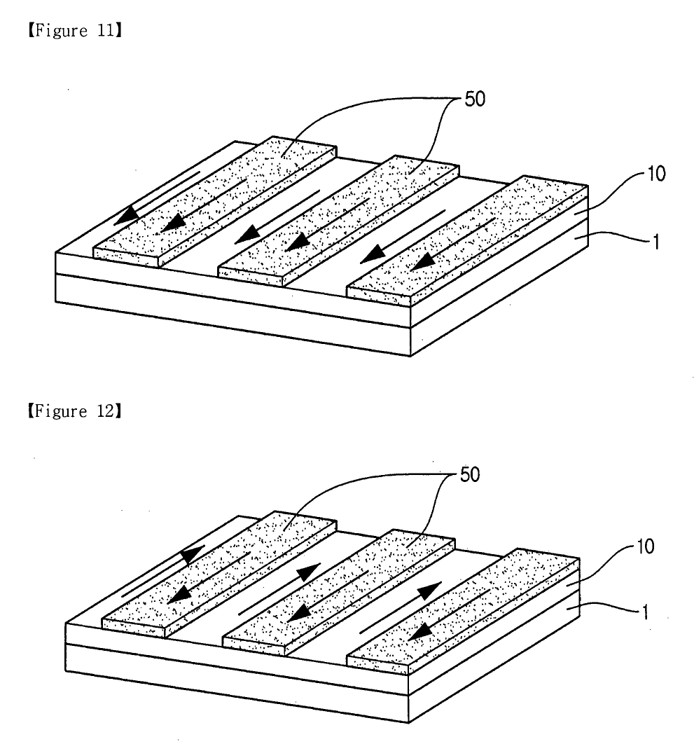

Referring to FIG. 11, the protective layer 50 on the stamping mold may be transferred onto the first vertical alignment layer 10. The protective layer 50 on the stamping mold is transferred onto the first vertical alignment layer 10 by a stamping process, and as a solvent evaporates, the protective layer 50 is formed on a partial region of the first vertical alignment layer 10. As a result, the partial regions of the first vertical alignment layer 10 are covered by the protective layers 50, while other partial regions are not covered by the protective layers 50 but are exposed. Here, the protective layers 50 may be positioned at regular intervals. Further, the regions covered by the protective layers 50 on the first vertical alignment layer 10 and the regions that are not covered by the protective layers 10 thereon may have the same area.

In FIGS. 10 and 11, processes of forming the protective layers 50 on the partial regions of the first vertical alignment layer 10 by forming the protective layers 50 on the stamping mold 5 and transferring the protective layer 50 onto the first vertical alignment layer 50 have been described. However, this is only an example, and in other example embodiments, the protective layers 50 may be formed on the partial regions of the first vertical alignment layer 10 by directly forming a protective film on the entire surface of the first vertical alignment layer 10 and partially removing the formed protective film. For example, the protective film may be partially removed using laser ablation by irradiating laser onto the protective film formed on the entire surface of the first vertical alignment layer 10.

In an example embodiment, the protective layer 50 may be made of a material which is chemically and/or mechanically stable. Further, the protective layer 50 may be made of a material that does not have an effect on the alignment characteristics of the first vertical alignment layer 10 or can minimize the effect. For example, in the vertical alignment layer 10 before and after the formation of the protective layers 50, the protective layer 50 may be made of a material of which an amount of change in the pretilt angle of, the liquid crystal adjacent to the first vertical alignment layer 10 satisfies the condition of Expression 1.

|Δθ|<0.50×|θ| [Expression 1]

In an example embodiment, the protective layer 50 may be made of a fluoropolymer material or other suitable materials.

Referring to FIG. 12, the first vertical alignment layer 10 having the protective layers 50 partially formed thereon may be subjected to the alignment process in one direction. Herein, the alignment direction may be different from that described with reference to FIG. 9, and, for example, may be a direction opposite to the alignment direction described with reference to FIG. 9. As a result, the alignment direction of the regions of the first vertical alignment layer 10 which are not covered by the protective layers 50 is changed. On the other hand, the regions of the first vertical alignment layer 10 which are covered by the protective layers 50 may maintain the alignment direction due to the protective layers 50.

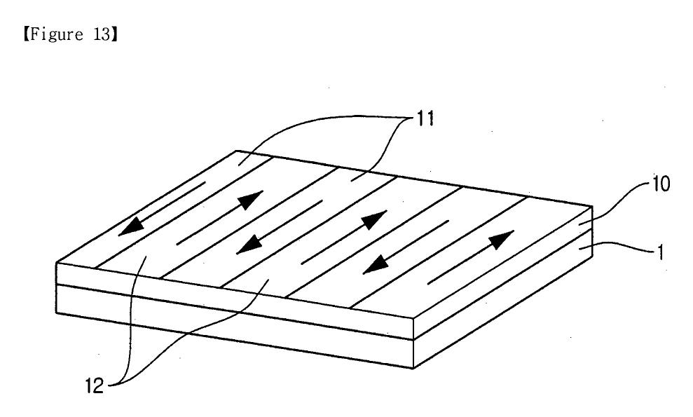

Referring to FIG. 13, subsequently, the protective layers may be removed. For example, in the case of the protective layers made of the fluoropolymer material, the protective layers may be removed using a fluorine-based solvent. The first substrate 1 from which the protective layers are removed may include the first and second regions 11 and 12 having different alignment directions. The plurality of first regions 11 and second regions 12 may be provided and arranged alternately. For example, the first and second regions 11 and 12 may have the shape of a strip and may be arranged alternately along one direction.

By the processes described above with reference to FIGS. 9 to 13, it is possible to manufacture the substrate for alignment of a liquid crystal including the first vertical alignment layer 10 including the first and second regions 11 and 12 having different alignment directions.

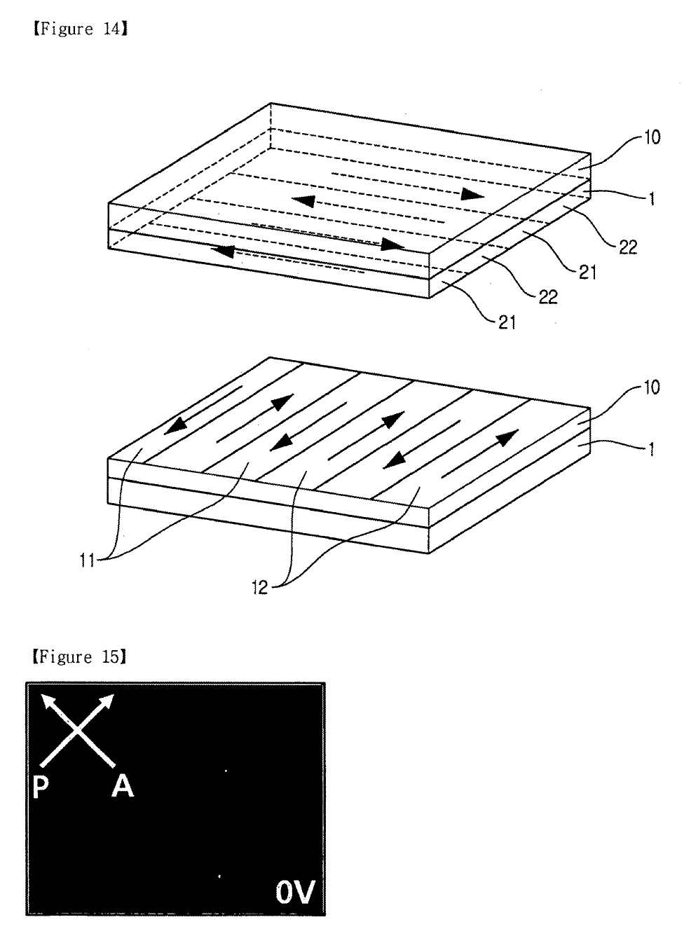

Referring to FIG. 14, by performing the processes described above with reference to FIGS. 9 to 13 to another substrate, the substrate for alignment of a liquid crystal comprising a second substrate 2 and a second vertical alignment layer 20 may be prepared. The second vertical alignment layer 20 may include third and fourth regions 21 and 22 having different alignment directions from each other.

Then, the first and second vertical alignment layers 10 and 20 may be disposed opposed to each other. Herein, the first and second vertical alignment layers 10 and 20 may be disposed so that the alignment directions thereof are different from each other. For example, the first and second vertical alignment layers 10 and 20 may be, disposed so that the alignment directions thereof are perpendicular to each other. Then, the liquid crystal (not shown) may be injected between the first and second vertical alignment layers 10 and 20.

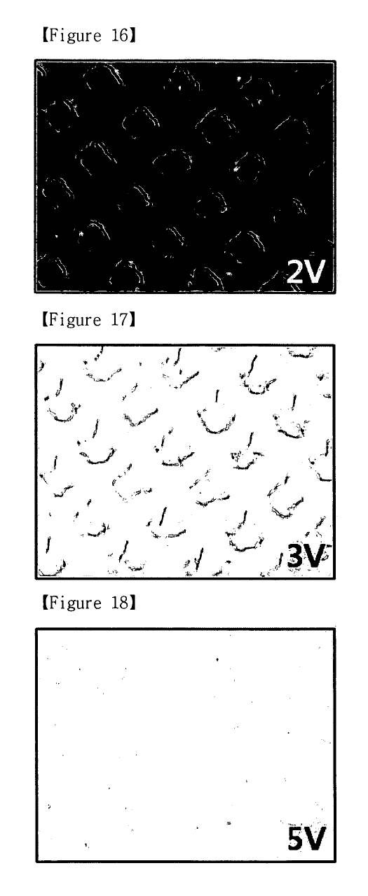

FIGS. 15 to 18 are optical micrographs of the liquid crystal display device according to an example embodiment taken by changing the voltage applied to the liquid crystal display device. The liquid crystal used herein for the liquid crystal display device is MLC6608 manufactured by Merck, and has a birefringence Δn of about 0.083 at a wavelength of about 589 nm and a dielectric anisotropy Δε of about −4.2. Further, a cell-gap thereof is about 5.2 μm, and an AC voltage at a frequency of about 1 kHz is applied as the driving voltage of the liquid crystal display device.

FIGS. 15 to 18 illustrate the liquid crystal display device when the voltage applied to the liquid crystal display device is about 0 V, 2 V, 3 V and 5 V, respectively. As illustrated, in the case of an initial vertical alignment state with no voltage applied, a dark state is exhibited. As the applied voltage is increased, it gradually turns to a bright state. Further, since four different twisted directions are formed depending on the alignment directions of the vertical alignment layers, four multi-domain alignment regions divided by disclination lines can be seen. As the voltage is increased, the liquid crystal molecules are arranged completely horizontally on the substrate surface and the disclination lines disappear such that a uniformly bright state is obtained.

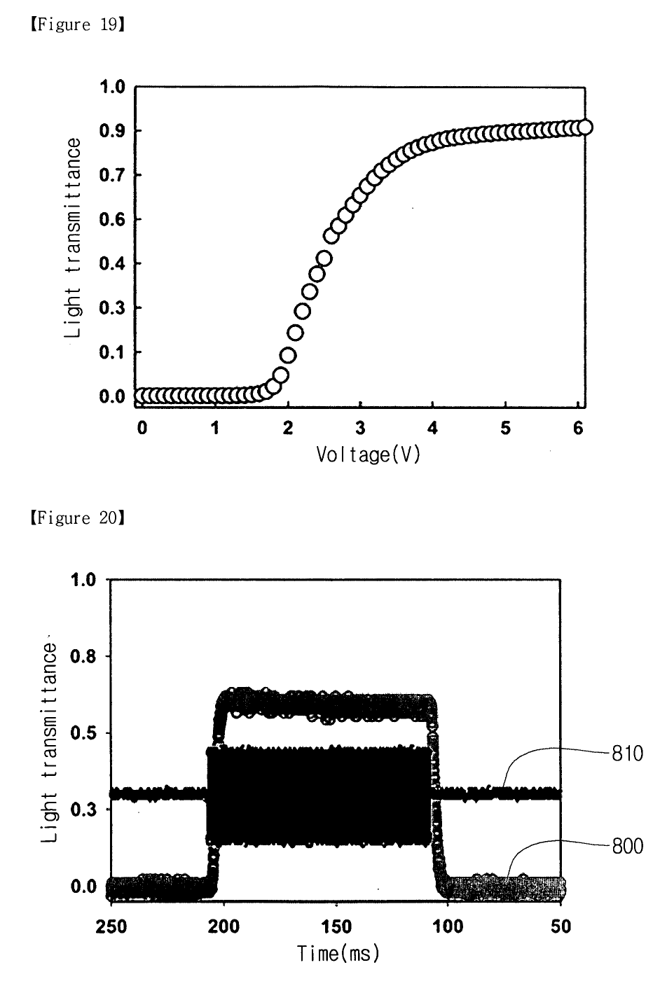

FIGS. 19 and 20 are graphs showing electro-optic characteristics of the liquid crystal display device according to an example embodiment. FIG. 19 is a graph showing light transmittance with respect to the voltage applied to the liquid crystal display device. The light transmittance was measured while increasing the applied voltage from 0 V to about 10 V at an interval of about 0.1 V. The measured light transmittances were represented as normalized values. FIG. 20 is a graph showing response time and light transmittance 800 with respect to the AC voltage 810 applied to the liquid crystal display device. A rising response time is defined as a time taken for the light transmittance to change from about 10% to about 90%, and a falling response time is defined as time taken for the light transmittance to change from about 90% to about 10%. As can be seen from FIG. 20, the liquid crystal display device has a quick response time of several milliseconds.

As illustrated in FIGS. 19 and 20, the liquid crystal display device according to the example embodiment exhibits stable light transmittance and quick response time. Thus, it can be seen that, unlike the conventional liquid crystal display device using a photoresist or a photo-alignment material, there is no problem with degradation in performance of elements and/or alignment instability.

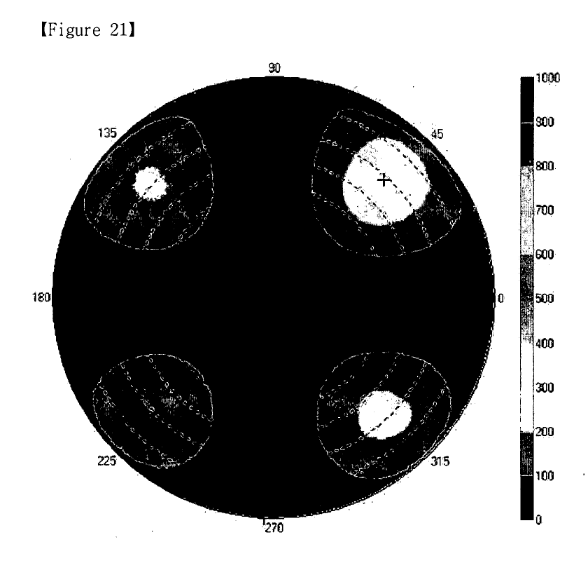

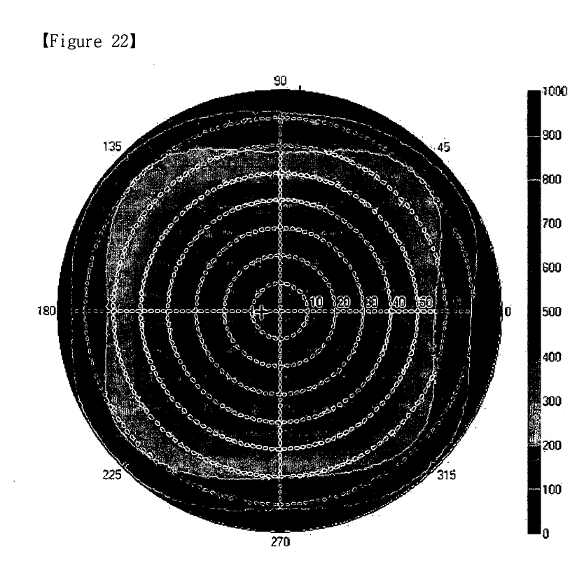

FIGS. 21 and 22 are graphs showing luminance characteristics depending on directions of the liquid crystal display device according to an example embodiment. FIG. 21 shows a luminance distribution in a dark state (or an off state) in which no voltage is applied to the liquid crystal display device, and FIG. 22 shows a luminance distribution in a bright state (or an on state) in which a voltage is applied to the liquid crystal display device. As illustrated, an amount of light leaking in the dark state is small in the liquid crystal display device according to the example embodiment. Further, a uniform luminance distribution is exhibited in all directions in the bright state, and thus the luminance distribution is relatively close to a circle in the liquid crystal display device according to the example embodiment.

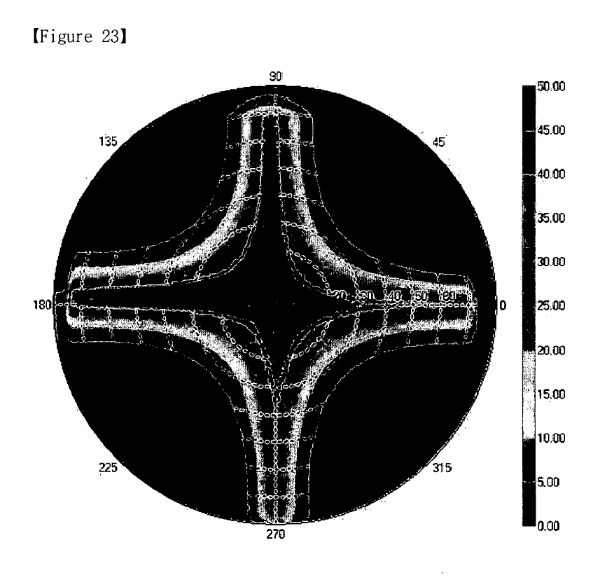

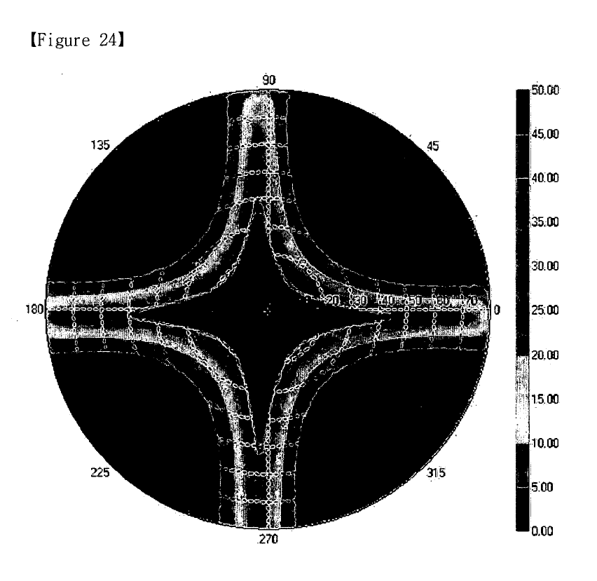

FIG. 23 is graph showing viewing angle of a conventional mono-domain ITN mode liquid crystal display device, and FIG. 24 is a graph showing viewing angle of the multi-domain liquid crystal display device according to an example embodiment. To compare FIGS. 23 and 24, in the liquid crystal display device according to the example embodiment, the luminance distribution is not biased in a specific direction as compared with the conventional liquid crystal display device and is relatively symmetrical. Further, the contrast ratio is high, and the viewing angle is wide in the liquid crystal display device according to the example embodiment. Therefore, it is possible to obtain the liquid crystal display device which can be manufactured by the relatively simple processes and has excellent viewing angle and contrast ratio.

While the example embodiments have been shown and described, it will be understood by those skilled in the art that various changes in form and details may be made thereto without departing from the spirit and scope of this disclosure as defined by the appended claims.

Further, many modifications can be made to adapt a particular situation or material to the teachings of this disclosure without departing from the essential scope thereof. Therefore, it is intended that this disclosure not be limited to the particular example embodiments disclosed as the best mode contemplated for carrying out this disclosure, but that this disclosure will include all embodiments falling within the scope of the appended claims.

### INDUSTRIAL APPLICABILITY

This disclosure relates to a liquid crystal display device, a method for manufacturing the same, and a method for manufacturing a substrate for alignment of liquid crystal.

1. A liquid crystal display device comprising:
a first substrate;
a second substrate opposed to the first substrate;
a first vertical alignment layer disposed on the first substrate, the first vertical alignment layer comprising a first region having a first alignment direction and a second region having a second alignment direction;
a second vertical alignment layer disposed on the second substrate to be opposed to the first vertical alignment layer, the second vertical alignment layer comprising a third region having a third alignment direction and a fourth region having a fourth alignment direction; and
a liquid crystal interposed between the first vertical alignment layer and the second vertical alignment layer,
wherein the first to fourth alignment directions are different from one another.

2. The liquid crystal display device according to claim 1, wherein the first and third alignment directions form an angle of about 45° to about 135°.

3. The liquid crystal display device according to claim 2, wherein the first and second alignment directions are opposite to each other.

4. The liquid crystal display device according to claim 2, wherein the third and fourth alignment directions are opposite to each other.

5. The liquid crystal display device according to claim 1,
wherein the first region and the second region are alternately arranged along one direction, and
wherein the third region and the fourth region are alternately arranged along a direction different from the one direction.

6. The liquid crystal display device according to claim 5, wherein the first region and the second region intersect the third region and the fourth region perpendicularly.

7. The liquid crystal display device according to claim 1, wherein the liquid crystal has a pretilt angle of about 45° to about 90° with respect to a surface of the first substrate at a region in proximity to the first vertical alignment layer.

8. The liquid crystal display device according to claim 1, wherein the liquid crystal has a pretilt angle of about 45° to about 90° with respect to a surface of the second substrate at a region in proximity to the second vertical alignment layer.

9. The liquid crystal display device according to claim 1, wherein the first region and the second region have the same area.

10. The liquid crystal display device according to claim 1, wherein the third region and the fourth region have the same area.

11. The liquid crystal display device according to claim 1, wherein the first vertical alignment layer and the second vertical alignment layer comprise material selected from the group consisting of a polyimide-based resin, a polyvinyl alcohol-based resin, a polyamic acid-based resin and a combination thereof.

12. The liquid crystal display device according to claim 1, further comprising:
a first polarizing plate disposed on a surface of the first substrate on the opposite side to the first vertical alignment layer; and
a second polarizing plate disposed on a surface of the second substrate on the opposite side to the second vertical alignment layer.

13. The liquid crystal display device according to claim 12, wherein polarization directions of the first polarizing plate and the second polarizing plate are perpendicular to each other.

14. The liquid crystal display device according to claim 12,
wherein a polarization direction of the first polarizing plate is parallel to the first alignment direction, and
wherein a polarization direction of the second polarizing plate is parallel to the third alignment direction.

15. A method for manufacturing a substrate for alignment of a liquid crystal, the method comprising:
forming a vertical alignment layer on a substrate;
performing an alignment process on the vertical alignment layer in a first direction;
forming a protective layer at a partial region of the vertical alignment layer;
performing an alignment process on other regions of the vertical alignment layer in a second direction; and
removing the protective layer.

16. The method according to claim 15, wherein the first direction and the second direction are opposite to each other.

17. The method according to claim 15, wherein performing the alignment process in the first direction comprises rubbing the vertical alignment layer.

18. The method according to claim 15, wherein performing the alignment process in the first direction comprises irradiating light onto the vertical alignment layer.

19. The method according to claim 15, wherein forming the protective layer on the partial region of the vertical alignment layer comprises:
forming the protective layer on a stamping mold; and
transferring the protective layer formed on the stamping mold onto the vertical alignment layer.

20. The method according to claim 19, wherein the stamping mold comprises an elastic material.

21. The method according to claim 15, wherein forming the protective layer on the partial region of the vertical alignment layer comprises:
forming a protective film on the entire surface of the vertical alignment layer; and
partially removing the protective film.

22. The method according to claim 21, wherein partially removing the protective film comprises irradiating a laser beam onto the protective film.

23. The method according to claim 15, wherein the protective layer comprises a fluoropolymer material.

24. The method according to claim 15, wherein performing the alignment process in the second direction comprises at least partially rubbing the vertical alignment layer.

25. The method according to claim 15, wherein performing the alignment process in the second direction comprises at least partially irradiating light onto the vertical alignment layer.

26. The method according to claim 15, further comprising disposing a polarizing plate on a surface of the substrate on the opposite side of the vertical alignment layer.

27. The method according to claim 26, wherein a polarization direction of the polarizing plate is parallel to the first direction and the second direction.

28. A method for manufacturing a liquid crystal display device, comprising:
forming on a first substrate a first vertical alignment layer comprising first region and second region having different alignment directions;
forming on a second substrate a second vertical alignment layer comprising third region and fourth region having different alignment directions;
disposing the first and second vertical alignment layers to be opposed to each other so that alignment directions of the first vertical alignment layer and the second vertical alignment layer are different from each other; and
injecting a liquid crystal between the first vertical alignment layer and the second vertical alignment layer.

29. The method according to claim 28, wherein disposing the first vertical alignment layer and the second vertical alignment layer to be opposed to each other comprises disposing the first vertical alignment layer and the second vertical alignment layer so that the alignment directions of the first vertical alignment layer and the second vertical alignment layer form an angle of about 45° to about 135°.

30. The method according to claim 28, wherein forming the first vertical alignment layer comprises:
forming the first vertical alignment layer on the first substrate;
performing an alignment process on the first vertical alignment layer in a first direction;
forming a protective layer on the first region;
performing an alignment process on the second region in a second direction; and
removing the protective layer.

31. The method according to claim 30, wherein the first direction and the second direction are opposite to each other.

32. The method according to claim 28, wherein forming the second vertical alignment layer comprises:
forming the second vertical alignment layer on the second substrate;
performing an alignment process on the second vertical alignment layer in a third direction;
forming a protective layer on the third region;
performing an alignment process on the fourth region in a fourth direction; and
removing the protective layer.

33. The method according to claim 32, wherein the third direction and the fourth direction are opposite to each other.

34. The method according to claim 28, further comprising:
disposing a first polarizing plate on a surface of the first substrate on the opposite side of the first vertical alignment layer; and
disposing a second polarizing plate on a surface of the second substrate on the opposite side to the second vertical alignment layer.

35. The method according to claim 34, wherein polarization directions of the first polarizing plate and the second polarizing plate are perpendicular to each other.

36. The method according to claim 34,
wherein a polarization direction of the first polarizing plate is parallel to an alignment direction of the first vertical alignment layer; and
wherein a polarization direction of the second polarizing plate is parallel to an alignment direction of the second vertical alignment layer.
